(19) United States
(12) Patent Application Publication
(10) Pub. No.: US 2016/0117624 A1
(43) Pub. Date: Apr. 28, 2016

(54) INTELLIGENT MEETING ENHANCEMENT SYSTEM

(71) Applicant: INTERNATIONAL BUSINESS MACHINES INCORPORATED, ARMONK, NY (US)

(72) Inventors: ROMELIA H. FLORES, KELLER, TX (US); ERIK H. KATZEN, ARGYLE, TX (US); SUMIT PATEL, IRVING, TX (US)

(21) Appl. No.: 14/521,820

(22) Filed: Oct. 23, 2014

(51) Int. Cl. G06Q 10/06; H04L 29/08

(52) U.S. Cl. CPC G06Q 10/06393; H04L 67/22; H04L 67/306

(57) ABSTRACT

A system, comprising hardware and software executing upon the hardware, for meeting handling that includes a set of stored user profiles, meeting profiles, meeting data, a meeting creation module, a meeting capture module, a meeting processor, and an evaluation module. During a meeting creation process, the meeting creation module can provide an interactive interface for collecting data from a meeting creator to create the meeting profile for the meeting. The meeting capture module captures data communicated between any of the meeting participants. The meeting processor analyzes the data to provide meeting recommendations as the meeting is being conducted. The evaluation module determines an effectiveness rating for the meeting and a performance rating for each of the meeting participant.

### BACKGROUND

The present invention relates to the field of electronic meeting systems and, more particularly, to an intelligent meeting enhancement system.

Meetings, online or otherwise, occur in three general phases: pre-meeting, the meeting, and post-meeting. The pre-meeting phase encompasses such tasks as determining logistics (e.g., when, where), identifying who should attend, and developing an agenda or another such document to guide the flow and/or discussion of the meeting. Tasks for the meeting phase occur as the meeting is being conducted like capturing meeting minutes, action items, and deliverable items. In the post-meeting phase, various participants perform their assigned tasks (i.e., executing action items and creating deliverable items), which typically also includes the creation of a document that summarizes the proceedings.

A wide variety of software systems and tools have been created that are related to these general meeting phases. However, the majority of these existing systems and tools focus only on the pre-meeting and/or meeting phases. Thus, conventional systems and tools do not address the entire process of developing, conducting, and resolving a meeting. The opportunity to leverage technology to enhance the overall process is being largely ignored. Thus, many of the basic processes associated with these meeting phases are technologically lagging behind available technological capabilities.

Many conventional meeting systems/tools operate with the expectation of users manually performing many of meeting phase tasks. For example, it is generally assumed that the meeting creator or leader will draft an agenda for the meeting. The meeting system/tool does not provide this user with any assistance with this task. Therefore, it quite possible for two similar meetings to have agendas containing different discussion topics; creation of the agenda is dependent upon the user's level of expertise with the topic. However, if these users were made aware of each other's meetings or provided the same assistance based on a predefined template, the agendas would be more similar and each subsequent meeting on the same topic would become more standardized.

As another example, one person attending the meeting is typically designated to take notes or meeting minutes. This results in the notes or minutes being skewed by what that designated person decides to be important, which may be a view not shared by other meeting participants. Conventional meeting systems do not provide objective analysis options to automatically generate various data views of the meeting.

### BRIEF SUMMARY

One aspect of the present invention can include a method for meeting handling where, during a creation process for a meeting, profile recommendations for defining a meeting profile for the meeting can be presented to a meeting creator by an intelligent meeting enhancement system. The profile recommendations can be based upon meeting profiles for previous meetings and/or previously-collected meeting data. The meeting profile can define meeting participants, meeting duration, meeting location, meeting keywords, and a meeting agenda. Meeting data can comprise a recording of the meeting and electronic documents associated with the meeting. The recording can utilize an audio format, a video format, a graphical format, and/or a textual format. When the meeting is conducted, the data communicated among meeting participants can be captured as the recording of the meeting. During the meeting, a meeting leader can be provided with meeting recommendations, such as an action item, a deliverable item, and/or a discussion topic. The meeting recommendation can be based upon the captured data of the meeting. A meeting participant can be assigned to action items, deliverable items, and similar task-like meeting recommendations. Upon completion of the meeting, an effectiveness rating of the meeting can be determined based upon a comparison of expectations contained in the meeting profile and actual characteristics of the completed meeting. The effectiveness rating can influence subsequent profile recommendations. After completion of the meeting, a summary document of the meeting can be automatically generated based on the captured data. Contents of the summary document can include meeting recommendations accepted by the meeting leader and results of data analysis performed on the data captured for the meeting. The summary document can be associated with the meeting profile for the meeting.

Another aspect of the present invention can include an intelligent meeting enhancement system that includes user profiles, meeting profiles, meeting data, a meeting creation module, a meeting capture module, a meeting processor, and an evaluation module. The user profiles can be used to store user-specific data for meeting participants. The meeting profiles can be for meetings that are currently-scheduled and that have been conducted. A meeting profile can define meeting participants, meeting duration, meeting location, meeting keywords, and a meeting agenda. The meeting data can include a recording of a meeting and electronic documents associated with the meeting. The recording can utilize an audio format, a video format, a graphical format, and/or a textual format. The meeting creation module can be configured to, during a meeting creation process, provide an interactive interface for collecting data from a meeting creator to create the meeting profile for the meeting. The meeting creation module can present the meeting creator with selectable profile recommendations for attributes of the meeting profile. The meeting capture module can be configured to capture data communicated between meeting participants. The data can include textual data, audio data, video data, and/or graphical data. The meeting processor can be configured to analyze the data captured by the meeting capture module to provide meeting recommendations as the meeting is being conducted. A meeting recommendation can be an action item, a deliverable item, and/or a discussion topic. The evaluation module can be configured to determine an effectiveness rating for the meeting and a performance rating for each meeting participant. The effectiveness rating can be based upon a comparison of expectations contained in the meeting profile and actual characteristics of the meeting as conducted. The performance rating of a meeting participant can be based upon data contributions of the meeting participant and can be stored in a user profile for the meeting participant.

Yet another aspect of the present invention can include a computer program product that includes a computer readable storage medium having embedded computer usable program code. The computer usable program code can be configured to, during a creation process for a meeting, present profile recommendations for defining a meeting profile for the meeting to a meeting creator. The profile recommendations can be based upon meeting profiles for other meetings and previously-collected meeting data for those meetings. The meeting profile can define meeting participants, meeting duration, meeting location, meeting keywords, and a meeting agenda. Meeting data can include a recording of the meeting and electronic documents associated with the meeting. The recording can utilize an audio format, a video format, a graphical format, and/or a textual format. The computer usable program code can be configured to, when the meeting is conducted, capture data communicated among meeting participants as the recording of the meeting. The computer usable program code can be configured to, during the meeting, provide a meeting leader with meeting recommendations, such as an action item, a deliverable item, and/or a discussion topic. A meeting recommendation can be based upon the captured data of the meeting. A meeting participant can be assigned to action items, deliverable items, and similar task-like meeting recommendations. The computer usable program code can be configured to, upon completion of the meeting, determine an effectiveness rating of the meeting based upon a comparison of expectations contained in the meeting profile and actual characteristics of the completed meeting. The effectiveness rating can influence subsequent profile recommendations. The computer usable program code can be configured to, after completion of the meeting, automatically generate a summary document of the meeting based on the captured data. Contents of the summary document can include meeting recommendations accepted by the meeting leader and results of a data analysis performed on the data captured for the meeting. The summary document can be associated with the meeting profile for the meeting.

### BRIEF DESCRIPTION OF THE SEVERAL VIEWS OF THE DRAWINGS

FIG. 1 is a schematic diagram illustrating a system supporting operation of an intelligent meeting enhancement system that provides users with comprehensive assistance during all phases of a meeting in accordance with embodiments of the inventive arrangements disclosed herein.

FIG. 1A is a block diagram illustrating the meeting creation module of the intelligent meeting enhancement system in accordance with embodiments of the inventive arrangements disclosed herein.

FIG. 1B is a block diagram illustrating the meeting capture module of the intelligent meeting enhancement system in accordance with embodiments of the inventive arrangements disclosed herein.

FIG. 1C is a block diagram illustrating the meeting processor of the intelligent meeting enhancement system in accordance with embodiments of the inventive arrangements disclosed herein.

FIG. 1D is a block diagram illustrating the evaluation module of the intelligent meeting enhancement system in accordance with embodiments of the inventive arrangements disclosed herein.

FIG. 2 is a flowchart of a method describing the general operation of the meeting enhancement system for meeting creation in the pre-meeting phase in accordance with an embodiment of the inventive arrangements disclosed herein.

FIG. 3 is a flowchart of a method 300 illustrating operation of the meeting enhancement system during the meeting and post-meeting phases in accordance with an embodiment of the inventive arrangements disclosed herein.

FIG. 4 is a collection 400 of example dashboard user interfaces 405 and 420 for creating a meeting in accordance with embodiments of the inventive arrangements disclosed herein.

### DETAILED DESCRIPTION

The present invention discloses a solution for enhancing the effectiveness of meetings. An intelligent meeting enhancement system can keep a history of meeting data and related documents to provide users with assistance when creating the meeting, during the meeting, and after the meeting. The meeting enhancement system can provide recommendations when creating the meeting as well as while the meeting is being conducted. These recommendations can be generated from similar meetings having a satisfactory effectiveness rating. The meeting enhancement system can capture and analyze data exchanged during the meeting to identify key points, action items, and deliverable items, and to recommend discussion topics, when necessary. After the meeting, the meeting enhancement system can analyze the captured data to automatically generate a summary as well as determine an effectiveness rating for the meeting and the meeting participants.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

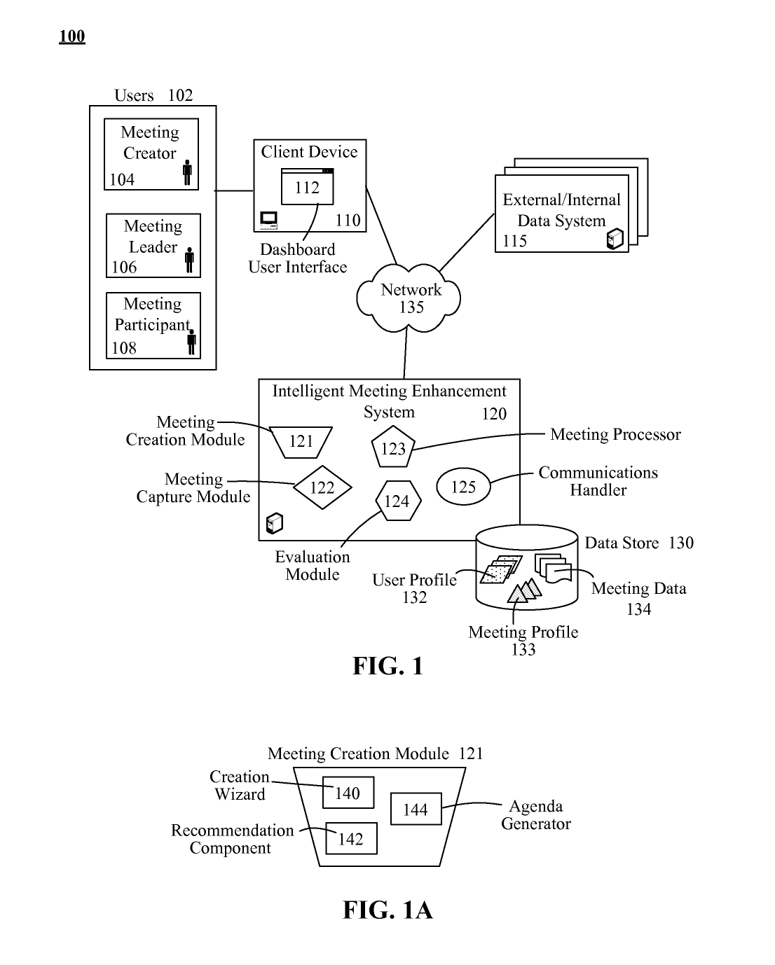

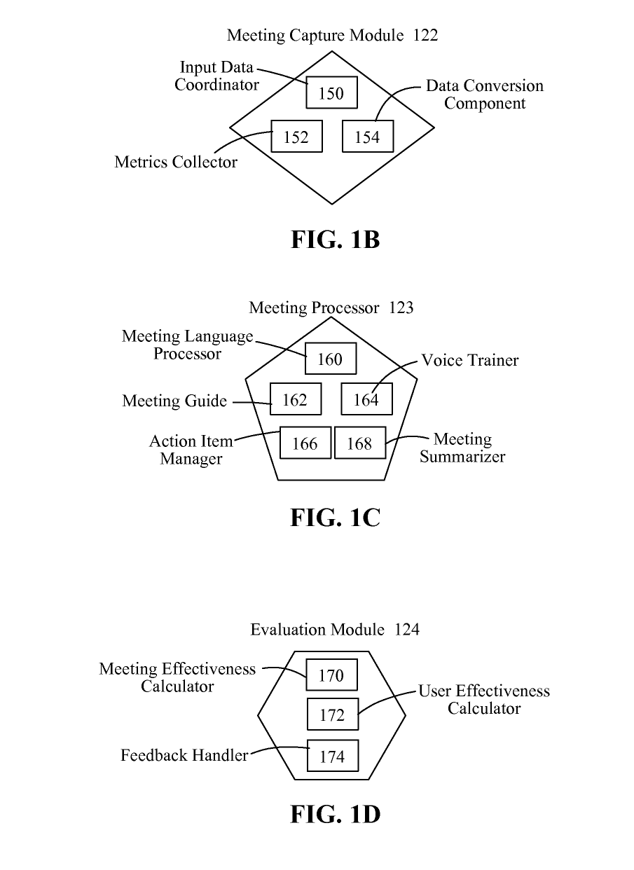

FIG. 1 is a schematic diagram illustrating a system 100 supporting operation of an intelligent meeting enhancement system 120 that provides users 102 with comprehensive assistance during all phases of a meeting in accordance with embodiments of the inventive arrangements disclosed herein. As used herein, a meeting can be said to be comprised of three phases: a pre-meeting phase, a meeting phase, and a post-meeting phase. The pre-meeting phase can encompass tasks associated with the creation of the meeting like scheduling and creating an agenda. The meeting phase can correspond to the meeting being conducted. Tasks in the meeting phase can include determining action items, deliverable items, and the next discussion topic and capturing notes about the meeting. The post-meeting phase can relate to the performance of tasks that are the results of the meeting like generating deliverable items as wells as creating and distributing a summary of the meeting.

In system 100, the intelligent meeting enhancement system 120, herein referred to as the meeting enhancement system 120, can be used to improve the overall effectiveness of meetings conducted among many users 102. The users 102 can be the human agents involved with the meeting process and can be further identified by their role played within this process to delineate their interactions with the meeting enhancement system 120.

The meeting creator 104 can be the user 102 responsible for creating the meeting within the meeting enhancement system 120 during the pre-meeting phase. The meeting leader 106 can be the user 102 that conducts the meeting for the meeting phase. The meeting leader 106 can also be the meeting creator 104. Meeting participants 108 can be those users 102 other than the meeting leader 106 that attend the meeting. The meeting creator 104 can also be a meeting participant 108.

Users 102 can interact with the meeting enhancement system 120 using a dashboard user interface 112 running on a client device 110. The client device 110 can represent a variety and/or combination of electronic devices capable of presenting the dashboard user interface 112 and communicating with the meeting enhancement system 120 over the network 135. The specific characteristics of the dashboard user interface 112 and/or client device 110 can vary based upon the type of meeting and/or implementation of the meeting enhancement system 120.

For example, the dashboard user interface 112 for a smartphone 110 can vary in functionality and appearance from the dashboard user interface 112 presented on a desktop computer 110. Further, a face-to-face meeting can use a dashboard user interface 112 configured with only options that are pertinent for audio capture, whereas an online meeting with video can have a dashboard user interface 112 with options for both audio and video.

The meeting enhancement system 120 can represent the hardware and/or software components necessary to provide intelligent recommendations throughout all three meeting phases. The meeting enhancement system 120 can include a meeting creation module 121, a meeting capture module 122, a meeting processor 123, an evaluation module 124, a communications handler 125, and a data store 130 containing user profiles 132, meeting profiles 133, and meeting data 134.

The meeting creation module 121 can represent the functions necessary for creating a meeting within the meeting enhancement system 120. The meeting creation module 121 can be used by the meeting creator 104 in the pre-meeting phase. As shown in FIG. 1A, the meeting creation module 121 can include a creation wizard 140, a recommendation component 142, and an agenda generator 144.

The creation wizard 140 can be the overall logic that guides the meeting creator 104 in creating a meeting profile 133 for the meeting being created. A meeting profile 133 can be a structure for storing and/or referencing basic characteristics of the meeting. Meeting profiles 133 can all follow the same data format and can be indexed to assist search functions.

For example, the meeting profile 133 can include a list of meeting participants 108 with assigned roles or priorities, basic logistic information (e.g., when, where, etc.), keywords that are of importance to the meeting, and an agenda.

The creation wizard 140 can present the meeting creator 104 with recommendations, provided by the recommendation component 142, for the various attributes of the meeting profile 133. The recommendation component 142 can be configured to provide the creation wizard with recommendations for meeting profile 133 attributes that are based upon analyses of user profiles 132, similar meeting profiles 133, and/or the meeting data 134 of similar meetings. That is, the recommendation component 142 can analyze sets of the historical data, using predefined logic/rules, to present the meeting creator 104 with the values that were most commonly used and/or were used in the most effective meetings.

Recommendations provided by the recommendation component 142 can include, but are not limited to, meeting participants 108, meeting duration, meeting location, keywords, discussion topics, objectives, deliverable items, and the like. Unlike some conventional meeting systems/tools that give recommendations for meeting participants 108 or scheduling information, the meeting enhancement system 120 can go beyond superficial characteristics and examine the effectiveness of attributes over time.

To provide recommendations for meeting participants 108, the recommendation component 142 can utilize data contained in the user profiles 132 for all users 102 of the meeting enhancement system 120. A user profile 132 can be used to store basic user info (e.g., name, role, location, etc.) as well as data specific to and/or generated by the meeting enhancement system 120 like performance ratings or other metrics.

The agenda generator 144 can provide logic specifically for creating an agenda or similar document for the meeting. The agenda generator 144 can work in concert with the recommendation component 142 to present suggestions to the meeting creator 104 and/or meeting leader 106 via the creation wizard 140. The agenda or similar document can utilize a predefined format or template. The agenda or document created by the agenda generator 144 can be stored with the meeting profile 133 or stored in an external/internal data system 115 accessible over the network 135 and a reference to the agenda can be stored in the meeting profile 133.

For example, the agenda generator 144 can use a template having various data blocks that need to be filled. The agenda generator 144 can task the recommendation component 142 to provide recommendations for these data blocks based on the agendas contained in the meeting profiles 133 of meetings that are similar in topic. The recommendations can then be presented, either entirely or sequentially, to the meeting creator 104 to help develop a thorough agenda for the meeting.

It should be noted that most conventional meeting systems/tools can overlook the importance of developing a thorough meeting agenda or other discussion guide. Many of these systems/tool can lack any type of assistance to develop such a document, let alone, one with this type of historical breadth. Thus, the meeting enhancement system 120 can improve the overall quality of the meeting by providing the meeting creator 104 or meeting leader 106 with a greater level of topic expertise and making them aware of what topics are being discussed in similar meetings.

An external/internal data system 115 can represent a computing system and/or program located either external or internal to the computing system and/or organization operating the meeting enhancement system 120 that provides additional functionality or data. Examples of external/internal data systems 115 can include, but are not limited to, an email system, a collaboration community, a social media system, a data server, a cloud storage system, a human resources system, an external Web site, a business process system, a word processing application, a spreadsheet application, and the like.

The meeting capture module 122 can represent the component of the meeting enhancement system 120 that establishes the meeting session and captures the proceedings of the meeting as meeting data 134. The meeting data 134 can represent all data, raw, augmented, and/or synthesized, exchanged among the meeting leader 106 and meeting participants 108. The meeting data 134 can include a recording of the meeting as well as any documents that were presented or referenced during the meeting. The recording of the meeting can utilize a variety of formats like audio, video, textual, graphical, or any combination thereof.

The meeting capture module 122, as shown in FIG. 1B, can include an input data coordinator 150, a metrics collector 152, and a data conversion component 154. The input data coordinator 150 can be configured to identify who is providing the captured data. The identity of the data contributor can be embedded with the captured data as metadata. The input data coordinator 150 can utilize a variety of techniques applicable for the type of data being captured, such as voice or face recognition, and the configuration of data channels being used.

For example, when multiple people are in a single conference room to participate in the meeting, the input data coordinator 150 can determine which of the meeting participants 108 is speaking. The determination can be made by matching the captured voice data against control samples, directionality, or a combination of such techniques.

The metrics collector 152 can be configured to collect metrics data from the captured data after being handled at least by the input data coordinator 150; additional metrics data can also be aggregated after handling by the meeting processor 123. Examples of metrics data gathered by the metrics collector 152 can include, but is not limited to, the amount of time taken to complete the meeting, the amount of time each meeting participant 108 talked during the meeting, the number of contributions made by each meeting participant 108, the type of contributions made by a meeting participant 108, and the like. The collected metrics data can be stored as meeting data 134.

The data conversion component 154 can be utilized to convert data between different file and/or data formats, when necessary for processing. For example, an optical character recognition (OCR) program can be used on an image of an item that contains text, like a certificate or form, to convert the image contents to a textual format.

In another contemplated embodiment, the data capture functionality of the meeting capture module 122 can be replaced with a third party meeting system (not shown) that provides a recording of the meeting. In such an embodiment, the remaining functionality of the meeting capture module 122 can be incorporated in the meeting processor 123.

It is important to note that the example of system 100 can be for an online meeting or a meeting that at least utilizes network 135 communications, whether audio and/or video. However, this should not be construed as a limitation of the present disclosure as the basic concepts taught herein can be applied to meetings having non-network 135 communications, such as a face-to-face meeting, without departing from the spirit of the present disclosure.

After data exchanges during the meeting have been captured and pre-processed by the meeting capture module 122, the meeting processor 123 can be triggered. The meeting processor 123 can represent the functionality of the meeting enhancement system 120 that analyzes the captured data to determine significant data points and the need to trigger additional system 120 operations. As shown in FIG. 1C, the meeting processor 123 can be comprised of a meeting language processor 160, a meeting guide 162, a voice trainer 164, an action item manager 166, and a meeting summarizer 168.

The meeting language processor 160 can embody the intelligence (i.e., logic and deductive rules) that analyze the data captured by the meeting capture module 122 to perform natural language analysis. The natural language analysis can allow the meeting language processor 160 to identify the context of and the emphasis put on various words or phrases contained in the captured data. The context and emphasis can then be used to determine a significance of and/or categorize a segment of data. The meeting language processor 160 can use keywords and/or phrases defined in the meeting profile 133 to assist in the identification of significant data elements.

For example, upon detection of the phrase “action item”, the meeting language processor 160 can mark the following segment of the data as an action item. The categorization can be included as metadata for that data segment. Additionally, the meeting language processor 160 can also indicate the topic being discussed as well as other context-specific information, such as the name of a referenced product or meeting participant 108, in the metadata.

The meeting language processor 160 can utilize the voice trainer 164 to determine emphasis. The voice trainer 164 can analyze captured voice data with respect to predefined standards to determine a tone and/or emotion being conveyed by the meeting participant 108. For example, words spoken louder than the baseline conversation volume and in an even timber can indicate that the speaker is speaking with intentional emphasis.

As previously mentioned, the designation of this component as a voice trainer 164 can be for illustrative purposes and the functionality of the voice trainer 164 can be expanded upon to handle forms of data other than audio in other embodiments of system 100. For example, text appearing in all capital letters or a larger font size can be considered to convey emphasis.

After processing the captured data, the meeting language processor 160 can provide the processed data to the meeting guide 162 and action item manager 166 for additional handling. The meeting guide 162 can be configured to analyze the general discussion flow of the meeting, based upon the context/topic indicated by the meeting language processor 160, and the meeting data 134 or similar meetings to provide the meeting leader 106 with real-time recommendations for controlling the meeting's discussion.

For example, the meeting guide 162 can identify that the discussion is fluctuating between customer requirements and product specifications. Based on this, the meeting guide 162 can identify previous meetings about the product and/or customer and analyze their meeting data 134 and/or meeting profiles 133 to recommend creating a traceability matrix to match customer requirements to product features. Further, the meeting guide 162 can provide the meeting leader 106 with a blank template of the traceability matrix that they can add to the meeting.

Additionally, the meeting guide 162 can also correlate the current topic flow of the meeting to the flow outlined in the agenda and the time allotted for the meeting. For example, the meeting guide 162 can populate a widget used in the dashboard user interface 112 of the meeting leader 106 with the amount of time left in the scheduled duration of the meeting as well as the topics left to discuss. Further, the meeting leader 106 can be provided with selectable actions based on the state of the meeting like extending the meeting time or scheduling a follow-up meeting. Selection of such actions can poll the other meeting participants 108 to provide the meeting enhancement system 120 and meeting leader 106 with feedback.

The action item manager 166 can be the component of the meeting processor 123 that aggregates data that the meeting language processor 160 has identified as “action items”. Upon completion of the meeting, the action item manager 166 can provide the meeting leader 106 with a list of all the identified action items. The meeting leader 106 can then provide additional information (e.g., due date, name of the responsible party, notes, etc.) or adjust the list as necessary. Once the meeting leader 106 has accepted the action item list, the action item manager 166 can send the responsible meeting participants 108 or other identified users 102 notifications with the information about their respective action items.

The action item manager 166 can also periodically send notifications to remind the users 102 about outstanding action items. Additionally, the action item manager 166 can document when the responsible user 102 indicates to the meeting enhancement system 120 that the action item has been completed. This indication can be received directly from the meeting leader 106, meeting participant 108, or via an external/internal data system 115.

For example, a meeting participant 108 responsible for calling a customer can inform the meeting leader 106 of the results of the call. The meeting leader 106 can then mark the action item as complete in the meeting enhancement system 120 using the dashboard user interface 112.

Once the meeting has concluded, the meeting summarizer 168 can examine the meeting data 134 created by the meeting language processor 160 to automatically generate a summary document for the meeting using predetermined logic and rules. The summary document can use a predefined template (not shown) that incorporates the categorizations assigned by the meeting language processor 160. For example, the template can include a block for listing action items and deliverable items as well as key comments made for each topic.

The summary document created by the meeting summarizer 168 can then be electronically stored in a designated external/internal data system 115 and referenced by the meeting profile 133 or stored with the meeting profile 133 of the meeting and/or distributed to the meeting creator 104, meeting leader 106, meeting participants 108, and/or absent users 102.

It can be important to note that the meeting summarizer 168 creates the summary document without the bias and embellishment often found in documents created by human users 102. Thus, the summary document can be an objective and factual recap of the meeting.

The evaluation module 124 can be the component of the meeting enhancement system 120 configured to assess the effectiveness of the meeting Like the action item manager 166 and meeting summarizer 168, the evaluation module 124 can be activated upon completion of the meeting. As shown in FIG. 1D, the evaluation module 124 can include a meeting effectiveness calculator 170, a user effectiveness calculator 172, and a feedback handler 174.

The feedback handler 174 can represent the element of the evaluation module 124 that solicits and compiles feedback about the meeting from the meeting leader 106 and meeting participants 108. The feedback handler 174 can utilize a predefined questionnaire and rating scale. The collected feedback data can be stored in the meeting data 134 for the meeting and can be used by the meeting effectiveness calculator 170 and user effectiveness calculator 172.

The meeting effectiveness calculator 170 can be configured to analyze the meeting data 134 processed by the meeting processor 123, including metrics data collected by the metrics collector 152, and applicable feedback collected by the feedback handler 174 to determine an overall effectiveness rating for the meeting in accordance with a predetermined formulation. The effectiveness rating can represent a quantitative expression of how well the meeting satisfied the expectations defined in the meeting profile 133, including objectives listed in the agenda. As a simplistic example, a meeting can be determined to have an effectiveness rating of 60% if only 3 of its 5 objectives were met.

Weighting values can be used to adjust the effectiveness rating to reflect a variety of qualitative properties. For example, the effectiveness rating can be increased by 10% if successfully completed in the expected time frame, and decreased by 2% for every 10 minutes of overrun.

The effectiveness rating of the meeting can be stored in the meeting profile 133 for the meeting and used by the recommendation component 142 of the meeting creation module 121 and the meeting language processor 160 of the meeting processor 123 to determine recommendations. That is, recommendations can be generated from meeting data 134 from meetings that meet a minimum effectiveness rating value.

The user effectiveness calculator 172 can, similarly, calculate an effectiveness rating for the meeting leader 106 and each meeting participant 108 from the meeting data 134 processed by the meeting processor 123, including metrics data collected by the metrics collector 152, and applicable feedback collected by the feedback handler 174. This user effectiveness rating can represent a quantitative expression of how well the user 102 contributed to the success of the meeting. A user's 102 effectiveness rating can be influenced by the user's 102 defined role for the meeting.

For example, a meeting participant 108 having a role of observer or trainee would not be expected to contribute to the meeting, and, therefore, could be exempt from having an effectiveness rating generated for the meeting. However, a meeting participant 108 with a role of expert or key contributor would be expected to have a high level of interaction during the meeting, and would have a relatively low effectiveness rating if they were mostly silent.

The user effectiveness calculator 172 can also be configured to adjust a user's 102 effectiveness rating based on the timeliness of action item completion. For example, user's 102 effectiveness rating can be 60% after the meeting with two action items pending. Completing the first action item on its due date can increase the user's 102 effectiveness rating to 75%; completing the second action item after its due date can then lower the effectiveness rating to 70%, or lower, if the delay then also delayed the completion of other action items or deliverables.

The user effectiveness calculator 172 can also provide an average effectiveness rating for users 102 based on their effectiveness ratings for all meetings that they have attended. This average rating as well as the effectiveness rating for each individual meeting can be stored or referenced in the corresponding user profile 132. These effectiveness ratings can affect recommendations regarding meeting participants 108 made by the recommendation component 142 to the meeting creator 104 when creating the meeting during the pre-meeting phase. The effectiveness ratings can also be used during the meeting phase when individuals ask the meeting creator 104 for recommendations of potential additional participants or action item aid provider to contact or include in future meetings.

The communications handler 125 can represent the hardware and/or software necessary to facilitate communications between the meeting enhancement system 120, client devices 110, and external/internal data systems 115. The communications handler 125 can be responsible for appropriately formatting electronic messages and establishing communication sessions. Additionally, the communications handler 125 can perform data security functions like message encryption/decryption.

As used herein, presented data store 130 can be a physical or virtual storage space configured to store digital information. Data store 130 can be physically implemented within any type of hardware including, but not limited to, a magnetic disk, an optical disk, a semiconductor memory, a digitally encoded plastic memory, a holographic memory, or any other recording medium. Data store 130 can be a stand-alone storage unit as well as a storage unit formed from a plurality of physical devices. Additionally, information can be stored within data store 130 in a variety of manners. For example, information can be stored within a database structure or can be stored within one or more files of a file storage system, where each file may or may not be indexed for information searching purposes. Further, data store 130 can utilize one or more encryption mechanisms to protect stored information from unauthorized access.

Network 135 can include any hardware/software/and firmware necessary to convey data encoded within carrier waves. Data can be contained within analog or digital signals and conveyed though data or voice channels. Network 135 can include local components and data pathways necessary for communications to be exchanged among computing device components and between integrated device components and peripheral devices. Network 135 can also include network equipment, such as routers, data lines, hubs, and intermediary servers which together form a data network, such as the Internet. Network 135 can also include circuit-based communication components and mobile communication components, such as telephony switches, modems, cellular communication towers, and the like. Network 135 can include line based and/or wireless communication pathways.

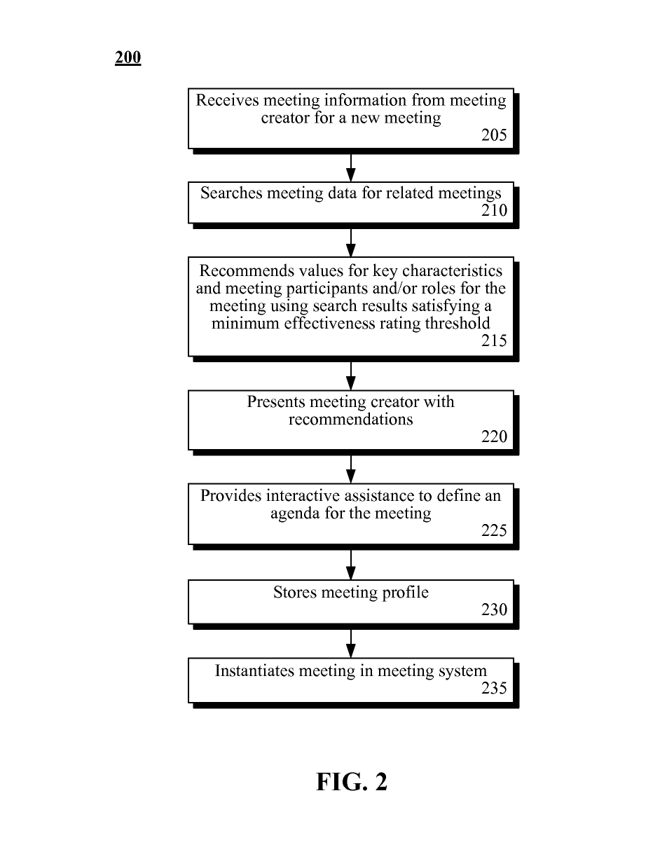

FIG. 2 is a flowchart of a method 200 describing the general operation of the meeting enhancement system for meeting creation in the pre-meeting phase in accordance with embodiments of the inventive arrangements disclosed herein. Method 200 can be performed within the context of system 100.

Method 200 can begin in step 205 where the meeting enhancement system can receive meeting information from the meeting creator for a new meeting (i.e., a meeting not already contained in the system). The meeting provided by the meeting creator in step 205 can be basic data like a meeting title, topic, and/or product. This data can be meant as a starting point and can be requested by the creation wizard.

Using the received data, the meeting data can be searched for related meetings in step 210. In step 215, recommendations can be made for key characteristics of the meeting and meeting participants and/or their roles using search results that satisfy a predefined minimum effectiveness rating threshold value.

The meeting creator can be presented with the recommendations in step 220. In step 225, interactive assistance can be provided to define an agenda for the meeting. The meeting profile can then be stored in step 230. In step 235, the meeting can be instantiated in the meeting system. If a third-party meeting system is used, step 235 can include passing the necessary data to that system.

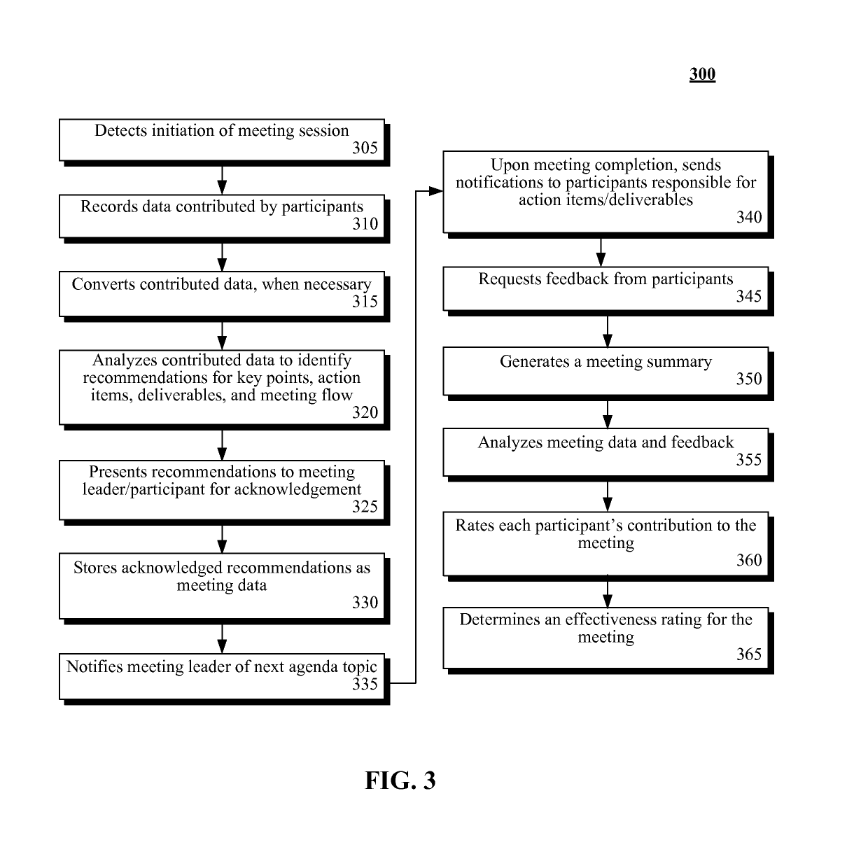

FIG. 3 is a flowchart of a method 300 illustrating operation of the meeting enhancement system during the meeting and post-meeting phases in accordance with embodiments of the inventive arrangements disclosed herein. Method 300 can be performed within the context of system 100 and/or in conjunction with method 200.

Method 300 can begin in step 305 where the meeting enhancement system detects initiation of the meeting session. Step 305 can occur automatically by the meeting enhancement system at the user-defined date and time. In the case of a face-to-face meeting, the meeting leader can manually initiate the meeting session in the meeting enhancement system.

Data contributed by the meeting participant and meeting leader can be recorded in step 310. When necessary, the contributed data can be converted between data types and/or formats in step 315.

In step 320, the contributed data can be analyzed to identify recommendations for key points, action items, deliverables, and meeting flow. The recommendations can be presented to the meeting leader and/or meeting participant for acknowledgement in step 325. In step 330, acknowledged recommendations can be stored as meeting data. The meeting leader can be notified of the next agenda topic for the meeting in step 335.

Upon completion of the meeting, steps 340-365 can be performed. In step 340, notifications can be sent to the meeting participants that have been identified as responsible for action items and deliverables. Feedback can be requested from the meeting participants in step 345. In step 350, a meeting summary can be generated.

The meeting data and feedback can be analyzed in step 355. In step 360, each participant's contribution to the meeting can be rated, producing an effectiveness rating for each participant. An effectiveness rating for the meeting can be determined in step 365.

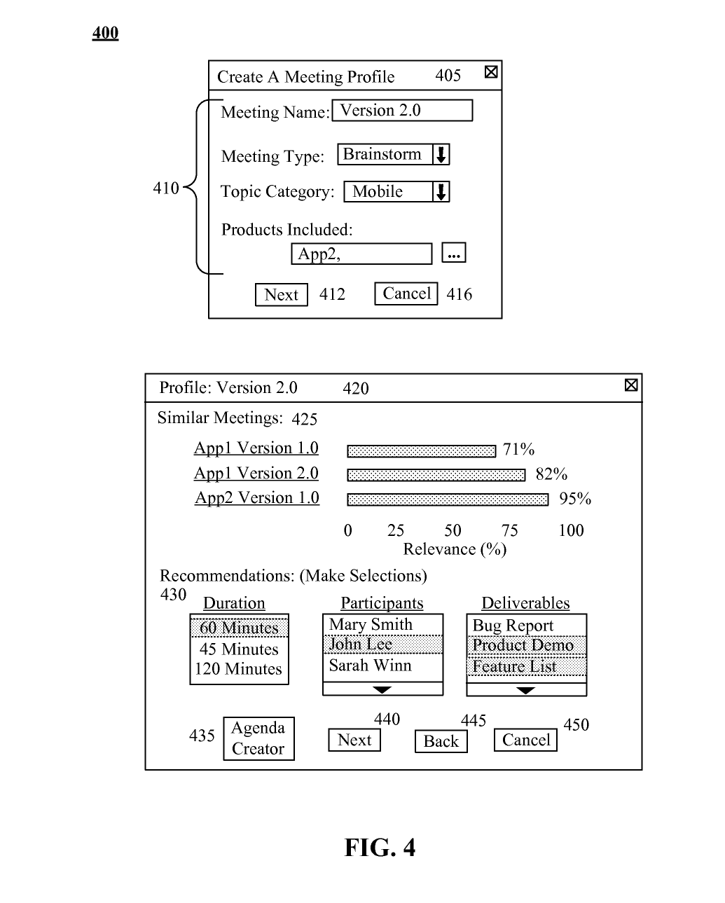

FIG. 4 is a collection 400 of example dashboard user interfaces 405 and 420 for creating a meeting in accordance with embodiments of the inventive arrangements disclosed herein. The interfaces 405 and 420 of collection 400 can be utilized within the context of system 100 and/or method 200.

The dashboard user interfaces 405 and 420 of collection 400 can be used as part of the creation wizard of the meeting creation module of the meeting enhancement system. Interface 405 can represent the initial window presented to the meeting creator. As such, interface 405 can include multiple data collection elements 410, a next button 412, and a cancel button 416.

The data collection elements 410 can be interaction mechanisms used that allow the meeting creator to enter and/or select values for the presented attributes. The data collection elements 410 should present the meeting creator with attributes that the creation wizard requires to proceed in its logic as well as for the recommendation component to utilize to determine recommendations. In this example, the data collection elements 410 can request a name for the meeting, a type for the meeting, a general meeting topic, and products that the meeting is about or affects.

Selection of the cancel 416 can terminate the meeting creation process within the meeting enhancement system. The next button 412 can submit the selected/entered data to the meeting creation module and can result in the presentation of interface 420 to the meeting creator.

Interface 420 can represent the next step of the creation wizard. Interface 420 can present the meeting creator with a variety of information and recommendations regarding the meeting that is being created. In this example, interface 420 can include a similar meetings area 425, recommendations 430, an agenda creator button 435, a next button 440, a back button 445, and a cancel button 450.

The similar meetings area 425 can present the meeting creator with information about similar meetings. In this example, the similar meetings area 425 can list the name of the similar meetings as well as a quantitative representation of their relevance to the meeting being created. The similar meetings area 425 can provide links to the meeting profiles and/or meeting data for those meetings that the meeting creator can select to view. This can provide the meeting creator with additional information to develop their meeting.

The recommendations 430 area can present the meeting creator with the recommendations for the various attributes of the meeting profile. Values presented in the recommendations 430 area can be gathered from the meetings presented in the similar meetings area 425 as well as other related meetings. It should be noted that the recommendations 430 area can be presented to the meeting creator in a variety of ways and that interface 420 can illustrate a simplistic example of the type and quantity of recommendations.

The agenda creator button 435 can activate the interface for the agenda generator that can provide the meeting creator with assistance for creating an agenda for the meeting. The next button 440 can store selected recommendation values in the meeting profile and advance the meeting creator to the next window of the creation wizard. The back button 445 can return the meeting creator to interface 405. The cancel button 445 can terminate the creation process.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An intelligent meeting enhancement system comprising:
a plurality of user profiles for meeting participants to store user-specific data;
a plurality of meeting profiles for meetings that are currently-scheduled and that have been conducted, wherein a meeting profile defines at least a subset of the meeting participants, meeting duration, meeting location, meeting keywords, and a meeting agenda;
a plurality of meeting data for a plurality of meetings that have been conducted, wherein the meeting data comprises at least a recording of a meeting and electronic documents associated with the meeting, wherein the recording utilizes at least one of an audio format, a video format, a graphical format, and a textual format;
a meeting creation module configured to, during a meeting creation process, provide an interactive interface for collecting data from a meeting creator to create the meeting profile for the meeting, wherein the meeting creation module presents the meeting creator with a plurality of selectable profile recommendations for attributes of the meeting profile;
a meeting capture module configured to capture data communicated between any of the meeting participants, wherein said data comprises at least one of textual data, audio data, video data, and graphical data,;
a meeting processor configured to analyze the data captured by the meeting capture module to provide meeting recommendations as the meeting is being conducted, wherein a meeting recommendation comprises at least one of an action item, a deliverable item, and a discussion topic; and
an evaluation module configured to determine an effectiveness rating for the meeting and a performance rating for each of the meeting participants, wherein the effectiveness rating is based upon a comparison of expectations contained in the meeting profile and actual characteristics of the meeting as conducted, wherein the performance rating of a meeting participant is based upon data contributions of the meeting participant, wherein the performance rating is stored in a user profile for the meeting participant.

2. The system of claim 1, wherein the meeting creation module further comprises:
a recommendation component configured to analyze the plurality of meeting profiles, the plurality of user profiles, and the plurality of meeting data to identify the profile recommendations;
an agenda generator configured to produce an agenda document for the meeting according to a predetermined format; and
a creation wizard embodying a logical and sequential process for collecting the data from the meeting creator.

3. The system of claim 1, wherein the meeting capture module further comprises:
an input data coordinator configured to identify and associate the captured data with the meeting participant contributing said data;
a metrics collector configured to analyze the captured data to calculate predefined metrics; and
a data conversion component configured to convert data from a first format to a second format, as required for analysis.

4. The system of claim 1, wherein the meeting processor further comprises:
a voice trainer configured to analyze the audio data to identify voice patterns that indicate data of importance to the meeting, wherein audio data containing meeting keywords are automatically flagged as important, wherein the voice trainer utilizes a learning algorithm for continuous improvement;
a meeting language processor configured to analyze a context and natural language elements of the audio data identified as important by the voice trainer to categorize the identified important data for use by other components according to a predefined schema, wherein the categorization is stored with the identified data as metadata attributes;
a meeting guide configured to, during the meeting, provide a meeting leader with notifications for discussion topics, wherein said discussion topics are based upon analysis of the important data categorized by the meeting language processor and the plurality of meeting data, wherein the meeting leader is the meeting participant designated as controlling the meeting in the meeting profile;
an action item manager configured to aggregate important data categorized as action items by the meeting language processor and validated by the meeting leader to produce a list of action items discussed in the meeting; and
a meeting summarizer configured to aggregate the important data by category to provide a summary document of a predefined format.

5. The system of claim 1, wherein the captured data is provided by a third-party meeting system, said system further comprising:
a user interface configured to act as a remotely-located interaction mechanism, wherein the user interface is able to receive user-entered data regarding the meeting and present a plurality of infographics using outputs of at least one of the meeting creation module, the meeting processor, and the evaluation module.

6. The system of claim 1, wherein the evaluation module further comprises:
a meeting effectiveness calculator, which analyzes meeting data to determine an overall effectiveness rating for the meeting;
a user effectiveness calculator, which calculates an effectiveness rating for the meeting leader and for each of the meeting participants; and
a feedback handler, which solicits and compiles feedback about the meeting from the meeting leader and from the meeting participants.

7. A method for meeting handling comprising:
during a creation process for a meeting, presenting of a plurality of profile recommendations for defining a meeting profile for the meeting to a meeting creator by an intelligent meeting enhancement system, wherein said plurality of profile recommendations are based upon at least one of a plurality of meeting profiles for a plurality of meetings and meeting data previously collected for the plurality of meetings, wherein the meeting profile defines at least meeting participants, meeting duration, meeting location, meeting keywords, and a meeting agenda, wherein meeting data comprises at least a recording of the meeting and electronic documents associated with the meeting, wherein the recording utilizes at least one of an audio format, a video format, a graphical format, and a textual format;
when the meeting is conducted, capturing data communicated among meeting participants as the recording of the meeting;
during the meeting, providing a meeting leader with at least one meeting recommendation, wherein a meeting recommendation comprises at least one of an action item, a deliverable item, and a topic for discussion, wherein said meeting recommendation is based upon the captured data of the meeting, wherein a meeting participant is assigned to action items, deliverable items, and similar task-like meeting recommendations;
upon completion of the meeting, determining an effectiveness rating of the meeting based upon a comparison of expectations contained in the meeting profile and actual characteristics of the completed meeting, wherein the effectiveness rating influences subsequent performances of the providing of the plurality of profile recommendations; and
after completion of the meeting, automatically generating a summary document of the meeting based on the captured data, wherein contents of said summary document comprise at least meeting recommendations accepted by the meeting leader and results of a data analysis performed on the data captured for the meeting, wherein the summary document is associated with the meeting profile for the meeting.

8. The method of claim 7, wherein presenting the meeting creator with the plurality of profile recommendations further comprises:
receiving preliminary meeting information from the meeting creator, wherein said preliminary meeting information comprises at least one of a meeting keyword, a meeting topic, and a meeting type;
searching the plurality of meeting profiles and meeting data for meetings relevant to the preliminary meeting information;
searching a plurality of user profiles for users having experience relevant to the preliminary meeting information; and
aggregating commonalities among the results of the searching steps into the plurality of profile recommendations to be presented to the meeting creator.

9. The method of claim 7, wherein capturing the data further comprises:
identifying the meeting participant providing audio data; and
associating said identification of the meeting participant with a corresponding segment of the captured audio data.

10. The method of claim 7, wherein providing at least one meeting recommendation further comprises:
analyzing the captured data in one of real-time and near real-time using data-appropriate analytics and the meeting profile;
identifying, based upon said analysis, a meeting recommendation;
presenting the identified meeting recommendation to the meeting leader in a graphical user interface;
receiving a response from the meeting leader for the presented meeting recommendation, wherein said response comprises an acceptance of the meeting recommendation and a rejection of the meeting recommendation; and
when the response is the acceptance of the meeting recommendation, storing the meeting recommendation in the meeting data for the meeting.

11. The method of claim 7, further comprising:
upon completion of the meeting, determining a performance rating for each meeting participant based upon contributions of the meeting participant, wherein the performance rating is allowed to change in response to the intelligent meeting enhancement system receiving at least one of an assessment from the meeting leader for the meeting participant and notification of completion for a task related to the meeting that the meeting participant was responsible for performing, wherein the determined performance rating is stored in a user profile associated with the meeting participant.

12. The method of claim 11, further comprising:
calculating an overall performance rating for the meeting participant based upon individual performance ratings determined for previous meetings.

13. The method of claim 7, further comprising:
upon completion of the meeting, automatically conveying notifications to meeting participants having been assigned at least one meeting recommendation.

14. The method of claim 7, further comprising:
upon completion of the meeting, requesting feedback from the meeting leader and the meeting participants, wherein received feedback is utilized when determining the effectiveness rating of the meeting.

15. A computer program product comprising a computer readable storage medium having computer usable program code embodied therewith, the computer usable program code comprising:
computer usable program code configured to, during a creation process for a meeting, present a plurality of profile recommendations for defining a meeting profile for the meeting to a meeting creator, wherein said plurality of profile recommendations are based upon at least one of a plurality of meeting profiles for a plurality of meetings and meeting data previously collected for the plurality of meetings, wherein the meeting profile defines at least meeting participants, meeting duration, meeting location, meeting keywords, and a meeting agenda, wherein meeting data comprises at least a recording of the meeting and electronic documents associated with the meeting, wherein the recording utilizes at least one of an audio format, a video format, a graphical format, and a textual format;
computer usable program code configured to, when the meeting is conducted, capture data communicated among meeting participants as the recording of the meeting;
computer usable program code configured to, during the meeting, provide a meeting leader with at least one meeting recommendation, wherein a meeting recommendation comprises at least one of an action item, a deliverable item, and a topic for discussion, wherein said meeting recommendation is based upon the captured data of the meeting, wherein a meeting participant is assigned to action items, deliverable items, and similar task-like meeting recommendations;
computer usable program code configured to, upon completion of the meeting, determine an effectiveness rating of the meeting based upon a comparison of expectations contained in the meeting profile and actual characteristics of the completed meeting, wherein the effectiveness rating influences subsequent performances of the providing of the plurality of profile recommendations; and
computer usable program code configured to, after completion of the meeting, automatically generate a summary document of the meeting based on the captured data, wherein contents of said summary document comprise at least meeting recommendations accepted by the meeting leader and results of a data analysis performed on the data captured for the meeting, wherein the summary document is associated with the meeting profile for the meeting.

16. The computer program product of claim 15, wherein presenting the meeting creator with the plurality of profile recommendations further comprises
computer usable program code configured to receive preliminary meeting information from the meeting creator, wherein said preliminary meeting information comprises at least one of a meeting keyword, a meeting topic, and a meeting type;
computer usable program code configured to search the plurality of meeting profiles and meeting data for meetings relevant to the preliminary meeting information;
computer usable program code configured to search a plurality of user profiles for users having experience relevant to the preliminary meeting information; and
computer usable program code configured to aggregate commonalities among the results of the searching steps into the plurality of profile recommendations to be presented to the meeting creator.

17. The computer program product of claim 15, wherein capturing the data further comprises:
computer usable program code configured to identify the meeting participant providing audio data; and
computer usable program code configured to associate said identification of the meeting participant with a corresponding segment of the captured audio data.

18. The computer program product of claim 15, wherein providing at least one meeting recommendation further comprises:
computer usable program code configured to analyze the captured data in one of real-time and near real-time using data-appropriate analytics and the meeting profile;
computer usable program code configured to identify, based upon said analysis, a meeting recommendation;
computer usable program code configured to present the identified meeting recommendation to the meeting leader in a graphical user interface;
computer usable program code configured to receive a response from the meeting leader for the presented meeting recommendation, wherein said response comprises an acceptance of the meeting recommendation and a rejection of the meeting recommendation; and
computer usable program code configured to, when the response is the acceptance of the meeting recommendation, store the meeting recommendation in the meeting data for the meeting.

19. The computer program product of claim 15, further comprising:
computer usable program code configured to, upon completion of the meeting, determine a performance rating for each meeting participant based upon contributions of the meeting participant, wherein the performance rating is allowed to change in response to the intelligent meeting enhancement system receiving at least one of an assessment from the meeting leader for the meeting participant and notification of completion for a task related to the meeting that the meeting participant was responsible for performing, wherein the determined performance rating is stored in a user profile associated with the meeting participant.

20. The computer program product of claim 15, further comprising:
computer usable program code configured to, upon completion of the meeting, automatically convey notifications to meeting participants having been assigned at least one meeting recommendation.
